(19) United States
(12) Patent Application Publication
(10) Pub. No.: US 2005/0119926 A1
(43) Pub. Date: Jun. 2, 2005

(54) Method and system for managing multi-national integrated trade and logistics and processes for efficient, timely, and compliant movement of goods across international borders

(76) Inventors: Leon Turetsky, Bedminster, NJ (US); Felix Pekar, Holmdel, NJ (US)

Correspondence Address: GRAFFITI PROMOTIONS, LLC, 827 WINDSOR ROAD, ARNOLD, MD, 21012, US

(21) Appl. No.: 10/724,908

(22) Filed: Dec. 1, 2003

(51) Int. Cl. G06F 17/60

(52) U.S. Cl. 705/8

(57) ABSTRACT

Proactive management methodology and system. The essential multi-national trade and logistics tasks, such as homeland security; calculation of landed costs; order fulfillment and performance; transportation of goods; tracking of goods; cross-border compliance verifications; storage of compliance and logistics data on the product/SKU level; valuation of goods; duties, fees, and tax calculations; accounting and financial processes; documents and reports generation; event management; and workflow control, are assigned to individual multi-tier software elements which make up the integrated building components of the computerized integrated trade and logistics management system. A centralized multi-lingual data repository schema allows server objects to share information in real-time mode and perform data collection and display functions on the client-side devices without installation of proprietary client-side software. Based on configurable rules, event and workflow managers generate parameters the handle services and modify the performance of dependant persistable objects and to communicate with the internal and outside stakeholders.

### CROSS REFERENCE TO RELATED APPLICATIONS

Not Applicable

### FEDERALLY SPONSORED RESEARCH

Not Applicable

### SEQUENCE LISTING OR PROGRAM

Not Applicable

A portion of the disclosure of this patent document contains material, which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD OF THE INVENTION

This invention relates in general to the field of supply chain management and, more particularly, to a multi-national integrated trade and logistics method and system for automating efficient, timely, and compliant movement of goods across international borders.

### BACKGROUND OF THE INVENTION

Movement of goods across international borders involves practically all supply chain stakeholders including manufacturers, shippers, freight forwarder agents, national government authorities, inland and international carriers, warehouses, container freight stations, customhouse brokers, importer, etc. The performance of many tasks requires the same information either in an electronic format or as a document. As an example, a Bill of Lading is necessary for transportation of goods, clearance of goods, and for a Letter of Credit.

Standalone, un-integrated business processes performed by individual participants are normally automated. Software programs running on different platforms and using different databases perform similar tasks in different fashions. Often, the same information, or parts of it, is entered into systems separately or, at best, standardized data transfer formats, such as EDI, EDIFACT, or XML are used to share the information. Results are the duplication and fragmentation of information, and substantial latency.

Many requests for information and documents exchanges are done on a fax of email levels. As an example, a purchaser is typically unable to determine the status of an order without placing a call or sending an email.

One of the main difficulties of an integrated system is the protection of sensitive and proprietary information. Data such as prices, rates, times, and even “best practices” cannot be shared between unrelated/uninvolved participants.

The situation is further complicated by the multiplicity: multiple languages, currencies, time zones, national trade and cross-border rules and regulations, homeland security, etc. While compliance cross-border software may exist for individual countries, there is no “one-stop” stop system that unifies and centralizes trade, finance, and logistics system as well as database schema and algorithms to collect, store, manipulate, and distribute such non-homogenous information.

A need therefore exists for software (system and methods) that enables end-to-end automation to the greatest degree possible, in a unified and synergistic fashion, the various aspects of efficient, timely, and compliant movement of goods across international borders. The present invention addresses this need.

### SUMMARY OF THE INVENTION

It is an object of the present invention to provide an improved method and computer system for trade and logistics management, in order to obtain efficient and compliant flow of goods across international borders, event management, and workflow control.

### OBJECTS OF THE INVENTION

(1) To consolidate all the disparate components of international cross-border processes into one multinational integrated system whereby any supply chain participant can access and deposit relevant almost anywhere in the world.
(2) To provide an export management system whereby an exporter can compliantly execute export transactions almost anywhere in the world and inform all interested parties.
(3) To provide an import management system whereby an importer can intelligently source and order products, and compliantly execute import transactions almost anywhere in the world and inform all interested parties.
(4) To provide a logistics management system whereby logistics services such as freight consolidation, de-consolidation, storage and transportation can be evaluated, selected, and executed almost anywhere in the world.
(5) To provide an event management system whereby any supply chain participant can control and configure relevant workflow.
(6) To provide a tracking system whereby any supply chain participant can determine the status of products during its movement readily accessible anywhere in the world.
(7) To provide a homeland security and compliance verification system for cross-border processes accessible anywhere in the world.
(8) To provide a self-upgradeable, all-inclusive multi-currency landed cost calculation system that accounts for all known and estimated costs, automatically improving quality and accuracy of results as more data becomes available.
(9) To provide an analytical and ad-hoc reporting tool and document production system to schedule and distribute documents and reports to all interested parties anywhere in the world.
(10) To provide a product/catalog management system to validate and store pre-classified and pre-defined data, and automatically extract said data for processing by relevant system components.

The objects of the invention are achieved by implementing a novel integrated system that provides an efficient solution to problems of compliance complexities, redundancy, and communicating between various trade and logistics systems, and allowing some sequential tasks to be executed in parallel mode. The entire integrated system is built around unique, all-inclusive products definitions within the unified multi-national database structure utilizing time-relational business model. A truly integrated system facilitates data transfer and automates many tasks, such as compliance verifications, export and import clearances, workflow management, event management, document and report generation, tracking and tracing, training for employees, etc. Furthermore, an integrated multi-national system fills the information gap between extended enterprise-level and process management systems to the point of un-attended automation when human intervention is required during exception occurrences only.

The present integrated trade and logistics system invention is an integrated cross-border system invention that utilizes unified multi-national database structure as the basis for providing an automatic link between any of the various system components and provides for an efficient and more powerful use of the managing information, addressing all aspects of movement of goods across international borders.

Furthermore, the present system invention utilizes unique and all-inclusive products definitions as the additional efficient link between any of the various system components and objects within the individual components. This features alone save considerable financial resources and time during order processing and cross-border movements.

Means to automate and integrate a full range of trade, finance, and logistics cross-border processes together with a schema, algorithms, products definitions, specification, and container structure and relationship within a unified multi-national database form a technical advantage of the present invention.

### BRIEF DESCRIPTION OF THE DRAWINGS

A more complete understanding of the present invention and the advantages thereof may be acquired by referring to the following description taken in conjunction with the accompanying drawings, in which like reference numbers indicate like features and wherein:

FIG. 1 illustrates a block diagram of the embodiment of a system for extended trade and logistics management of moving goods across an international border according to the teachings of the present invention;

FIG. 2 illustrates a deployment architecture diagram of embodiment of deployment of system;

FIGS. 3(a) and (b) illustrate block diagrams of embodiment of a system for descriptive export management;

FIG. 4 illustrates a block diagram of embodiment of a system for generalized import management;

FIGS. 5(a), (b), and (c) illustrate block diagrams of embodiment of a system for descriptive import management;

FIGS. 6(a) and (b) illustrate block diagrams of embodiment of a system for generalized clearance of goods on the import side of an international border;

FIG. 7 illustrates an event management calendar to control workflow of business processes;

FIG. 8 illustrates a documents binder calendar to control compliance of import and export processes;

FIG. 9 illustrates a Harmonized Tariff Schedule screen of the HTS classifier component;

FIG. 10 illustrates a query screen of the reporting component;

FIG. 11 illustrates a license verification screen of the homeland security component;

FIG. 12 illustrates a sample database model of transaction cross-reference implementation using the separate cross-reference table.

### DETAILED DESCRIPTION OF THE INVENTION

Architecture

Referring now to FIG. 2 that illustrates the system by showing the integration of various components and systems. A centralized database structure (204) is the essential of the system and integrates together the various management components information. Integration (210 & 211) is distinct from interfacing and provides for a higher level of communication, versatility, and data processing capability. Integration means that the various trade, finance and logistics systems are linked to a unified database that uses a uniform structure for storing and processing data. All entered information (208 & 209) must be qualified by management components and verified against pre-defined and configurable business rule before it is committed to the centralized database. Such qualification is based on actual compliance regulations and industry-accepted standards, and differs qualitatively from the type of data validation typically performed in database systems. This invention is not limited by the specific content, structure, communication protocols, and location of the data repository.

Physically, the unified data repository can be a part of a distributed system that may be on multiple machines. An interfaced system, in comparison, may have the same data stored in different locations and in different, often incompatible, database structures.

Logically, the present automated business process and data repository may be split into two parts: private data (205), such as transactions (e.g., shipments, commercial invoices, purchase orders, containers, manifests) collected from dedicated participants (200) (e.g., importers, exporters, freight forwarders, carriers) and public data (206) such as reference tables (Harmonized Tariffs, codes) and transactions (e.g., shipments, commercial invoices, purchase orders, containers, manifests) collected from shared participants (e.g., freight forwarders, carriers, customs brokers) utilizing TradeMaster (207).

Participants may obtain access to the database through the Internet (201) or the like. Today, the Internet as the current global communications environment provides the most appropriate way to exchange the information. Other communications environments either existing or developed in the future can be used as well. The physical location of the database and data collection devices becomes irrelevant, as they can be anywhere in the world, either through wired or wireless communications. A security scheme, such as encryption, implemented in either hardware or software may be provided between the data collection interfaces and the centralized data repository.

Event Management, configurable Workflow, Track and Trace

Each external system deposits information at the point of origin at the time when information becomes available. Updated information can be entered into the data repository (203) at any time providing that it is not to late to modify behavior of a system component affected by the change (a product cannot be simply re-classified and submitted for clearance after it had been already released by the Customs; the different established procedure must be followed). In such cases updates are rejected and the originating system is notified.

External actions, dependencies, and influences occurred during the managing of a business process are recorded as events, mostly action items, and documents binders defined as sets of documents mandatory for a particular business process. Said events and document binders can be scheduled in advance and are continuously monitored.

All failures and happenstances are recorded and cause notification of the parties responsible for the process through any available communication method including email. Failures and happenstances can cause scheduling of other events and can modify the statuses and locks of other transactions and modify behavior of affected system components (containers that should be delivered to the USA cannot be loaded onto the ship without prior approval from the US Customs Service; therefore, the delivery transaction is locked until approval to load is received).

Rules to modify components behavior are configurable and timely and accurately adjust the workflow minimizing negative effects that can be caused by inaction due to the lack of information or by missing an event, as it is common in the prior state of art systems. The configurable workflow allows some business processes to be executed in parallel, thus improving the performance of the enterprise-wide system, while forcing other business processes to wait for completions of pre-requisite tasks and to be executed sequentially, thus ensuring compliance with trade and cross-border standards and regulations.

The proactive event manager includes three components: a) Collection Agent for collecting and storing data; b) Event Agent, which monitors execution and status of events and document binders to trigger generation of chained events and distribution of notifications messages; and c) a Configuration Agent, which configures the workflows by updating locks and statuses.

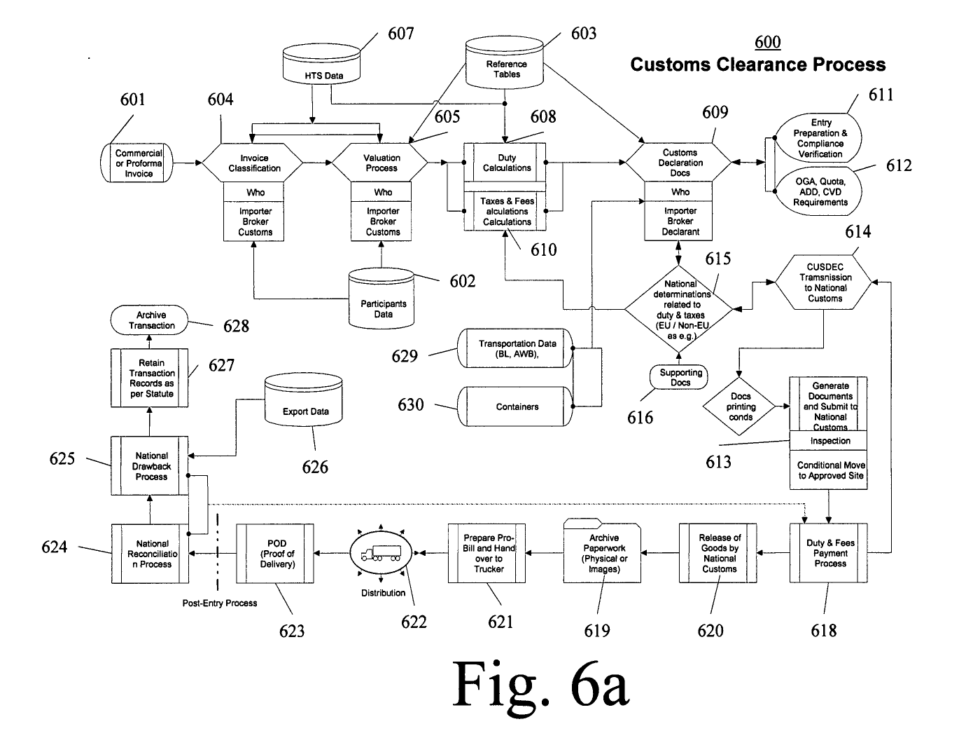

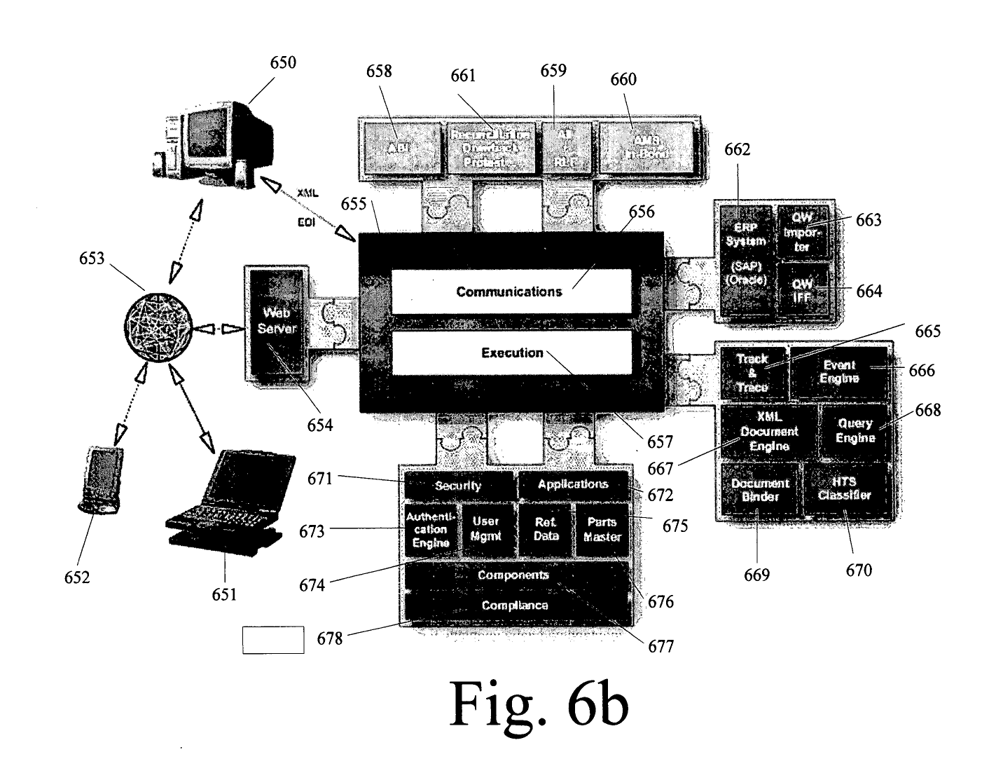

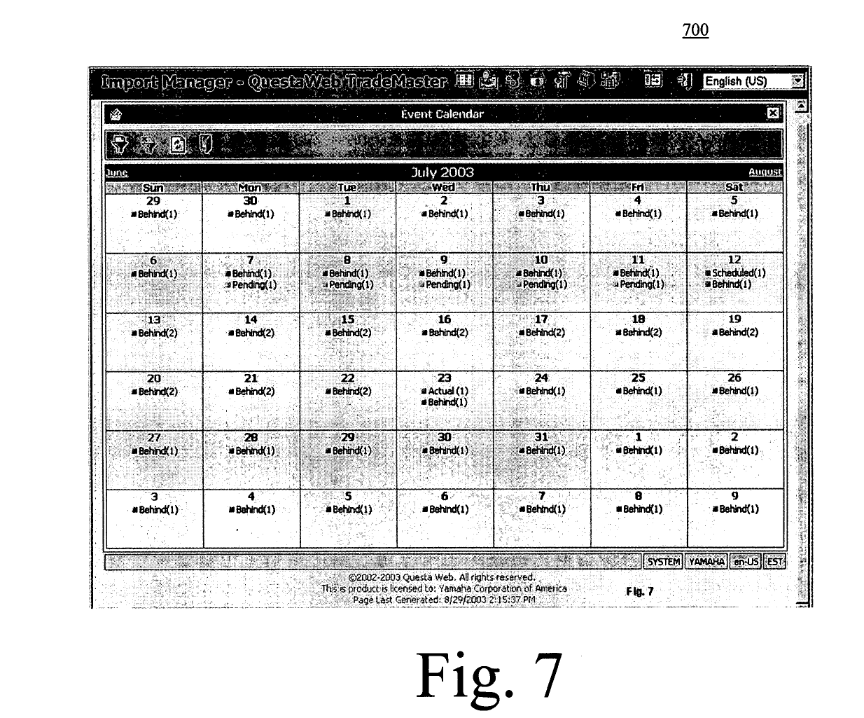

FIG. 7 illustrates the calendar showing scheduled, pending, registered, and failed to happen events (700) could be displayed at any moment together with the facilities to “drill down” to specific events. All events are also available in the Track and Trace component of the system, where all schedules and events associated with movement and processing of goods are linked to the integrated transactions.

FIG. 8 illustrates the calendar showing registered and missing compliance documents (800) could be displayed at any moment together with the facilities to “drill down” to specific document. Missing documents can affect the business workflow prohibiting execution of dependant functions and/or integrated transactions.

Business Process

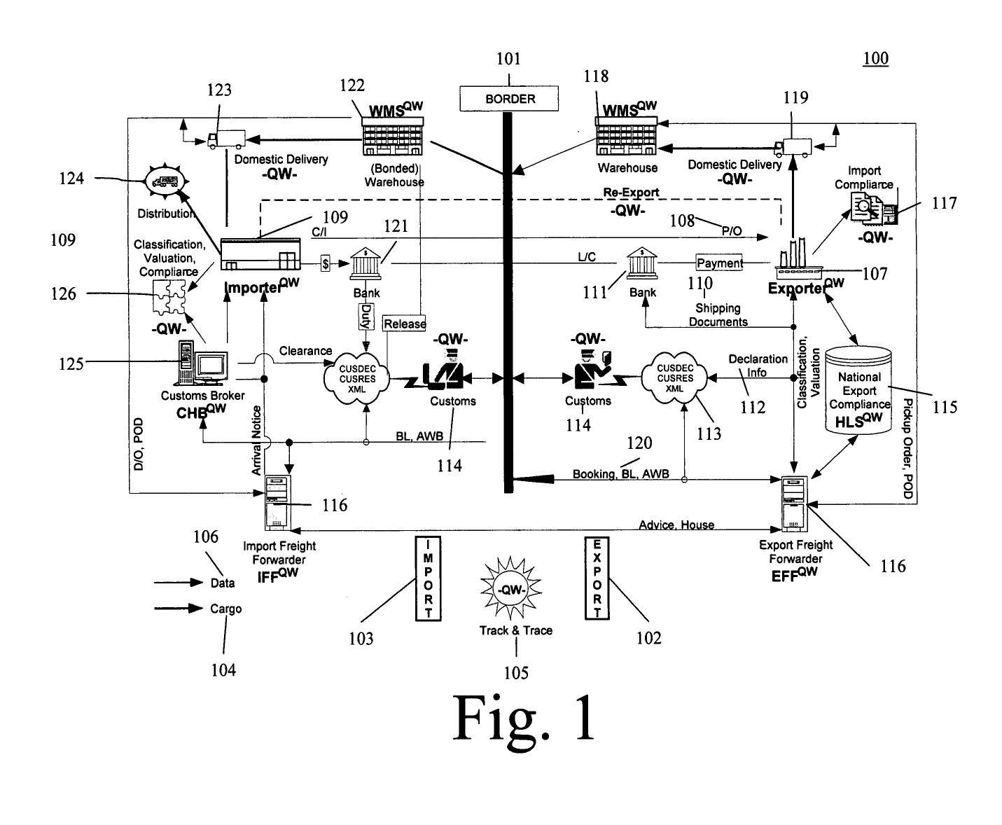

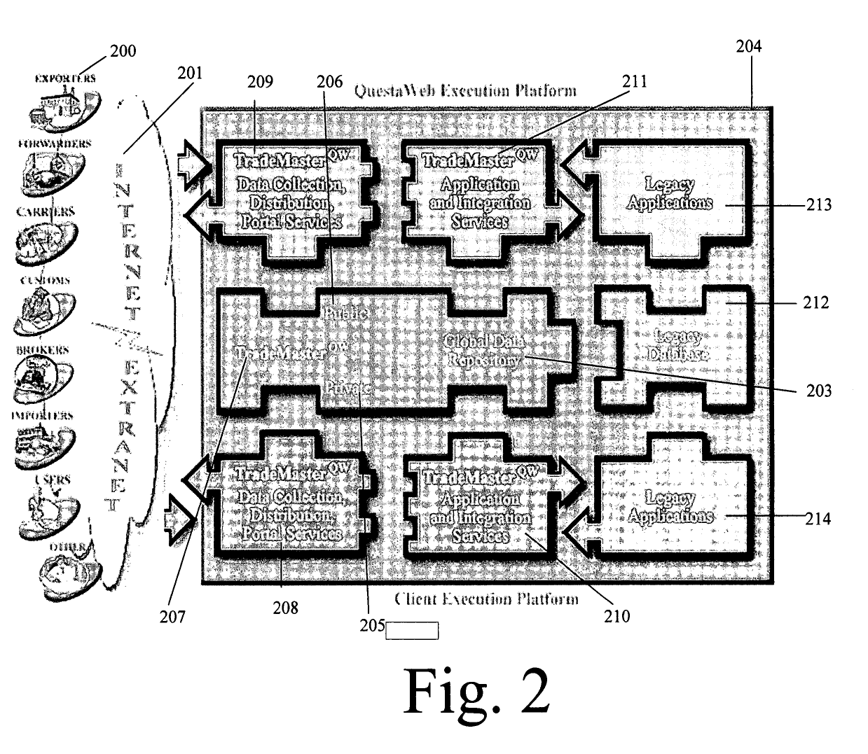

An overview of the present automated business process (100) is shown in FIG. 1. The components denoted with letters “QW” are automated components for the trade and logistics management system of the present invention. At the Border (101) either the export (102) or import (103) of cargo (104) occurs. The present invention describes and automated business process (100) that not only tracks and traces (105) cargo (104), but also tracks and traces (105) data (106).

Still referring to FIG. 1 the export (102) process initiated with the exporter (107) receiving a purchase order (108) from an importer (109). The exporter (107) provides shipping documents (110) to the exporter's bank (111), declaration information (112) in CUSDEC, CUSRES or XML format (113) to Customs (114). The exporter (107) may access a national export compliance database (115) and export freight forwarder (116) to generate an import compliance report (117). The Exporter (107) may then ship the product to a warehouse (118) if it is a domestic delivery (119) otherwise the transportation process will be booked (120). Once the product is being exported, the importer (109) will utilize his account at an importer bank (121) to send a payment to the exporter's bank (111).

Still referring to FIG. 1 the importer (109), when placing an order may access the import freight forwarder (116), a customs broker (125) and classification, valuation and compliance databases (126). If importing non-domestic product, but if the product is domestic, the product is delivered form a warehouse (122) via domestic delivery (123) to the importer (109) for distribution (124).

The system monitors every step of the business process in accordance with the configured workflow, validates all data in accordance with established business rules, and creates tracking events. Information and documents are distributed to the participants in accordance with established communication procedures. Data stored in the centralized database becomes immediately available to all authorized parties with appropriate sign-on and data access privileges assigned by system administrators.

During record input, the system prompts the user at every opportunity. For example, when the cursor is placed within the customer field, a list of existing customers can be displayed. Assuming the customer is a repeat customer, the user can select the customer from the list. Various fields are then completed from information previously stored for that customer. The same is true for many other fields, e.g., ports, countries, codes, dates, and so on. On-line help is provided for every field on every screen. Mandatory data must be entered before information can be committed to the database. Information stored in the product file is used whenever possible to reduce and verify data input. Audit trail reflects all changes made to the pre-defined fields together with a timestamp and an operator id.

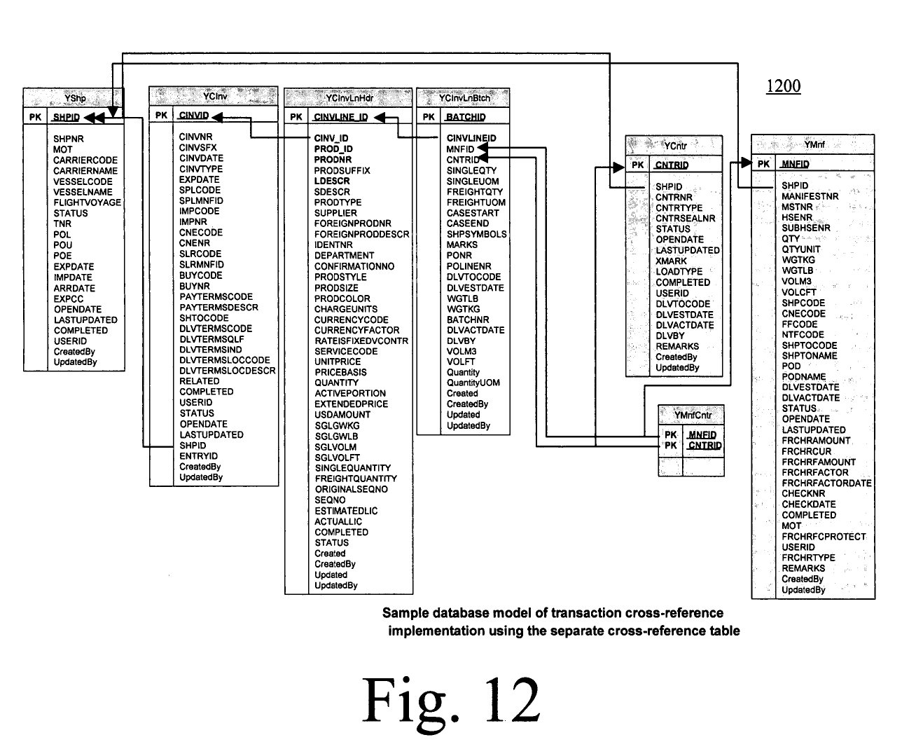

One of the concepts of the invention is the ability of the system to attach/detach (or link/un-link, or connect/disconnect) transactions, such as manifests/bills of lading, containers, commercial invoices, etc., to each other and to application components, such as export, import, freight forwarding, etc. Such attachments are made by pacing cross-reference pointers to the transactions (e.g., unique database keys or Ids) either in the transaction table or in the separate cross-reference table. FIG. 12 shows a sample database model of transaction cross-reference implementation using the separate cross-reference table.

This technique allows processing of all types one-to-one, one-to-many, many-to-many, and many-to-one relations between transactions (e.g., one container can be contained in multiple bills of lading, or one bill of lading can be in multiple containers). It also allows to separate delete and detach functions (e.g., deletion of a commercial invoice means it is not available to any system component, whereas detachment of attachment of the invoice to a specific component affects the specified component only).

The system works on the exception basis whereas the user is notified of errors and potential problems; otherwise the process proceeds to the next step automatically. All reports and documents produced by the system can be scheduled and distributed automatically to all registered parties anywhere in the world.

(1) Export Management

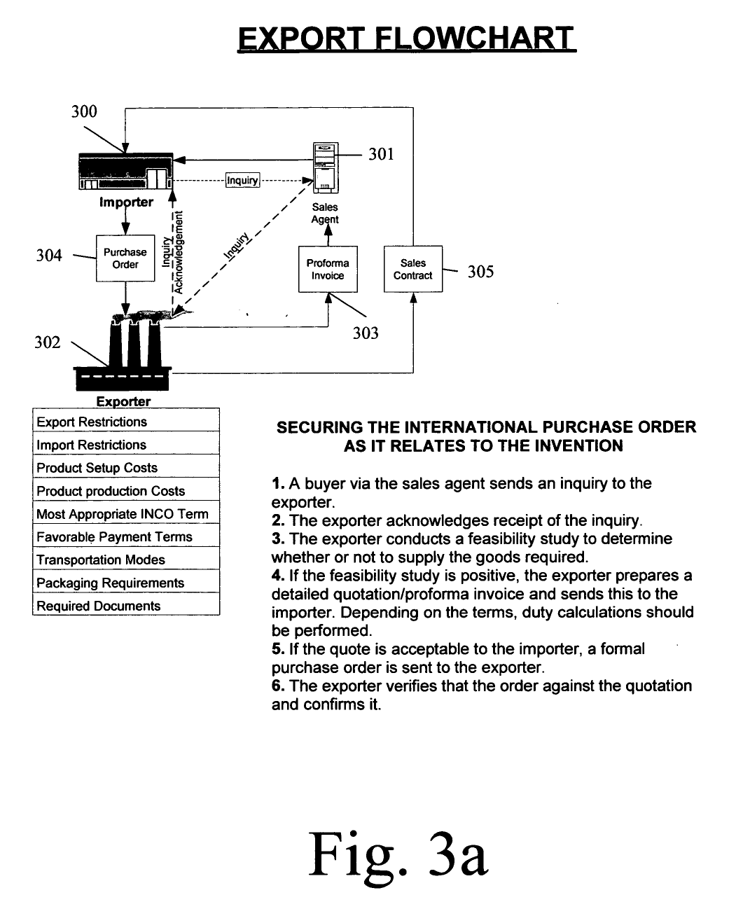

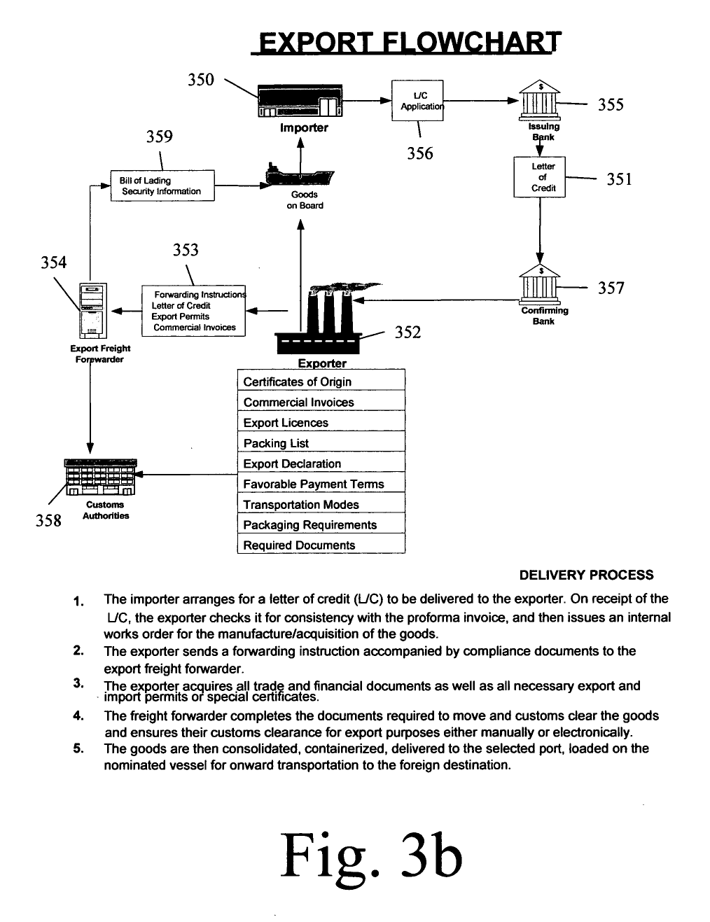

Referring now to FIGS. 3(a) & (b) that illustrate an overview of the automated components for management of the export process according to the teachings of the present invention.

Now referring to FIG. 3a, securing the international purchase order as it related to the present invention is illustrated. An importer (300) via a sales agent (301) sends as inquiry to the exporter (302). The exporter (302) acknowledges receipt of the inquiry. The exporter conducts a feasibility study to determine whether or not to supply the goods required. If the feasibility study is positive, the exporter prepares a detailed quotation/proforma invoice (303) and sends this to the importer (300). Depending on the terms, duty calculations should be performed. If the quote (303) is acceptable to the importer (300), a formal purchase order (304) is sent to the exporter (302). The exporter (302) verifies the order (304) against the quotation (303) and confirms it in a sales contract (305).

Now referring to FIG. 3b the delivery process of the present invention is illustrated. The importer (350) arranges for a letter of credit (L/C) (351) to be acquired from an issuing bank (355) by submitting an application (356) for approval and delivered to the exporter (352) via a confirming bank (357). On receipt of the L/C, the exporter checks it for consistency with the proforma invoice, and then issues an internal works order for the manufacture/acquisition of the goods. The exporter sends a forwarding instruction accompanied by compliance documents (353) to the export freight forwarder (354). The exporter acquires all trade and financial documents as well as all necessary export and import permits or special certificates. The freight forwarder (354) completes a bill of lading (359) and the other documents required to move and customs clear the goods and ensures their customs clearance for export purposes either manually or electronically through the customs authorities (358). The goods are then consolidated, containerized, delivered to the selected port, loaded on the nominated vessel (360) for onward transportation to the foreign destination and ultimately the importer (350).

Based on sales quotes, a three-tiered purchase order consisting of a header, product line, and one or more batches is created by an exporter using selected sourcing information of “what if” scenarios provided by the automated component of the system. The requested landed cost is calculated by the system at this point and security compliance is being verified at every step from this point on.

Upon manufacturing or purchasing requested products, an exporter generates a delivery note connected to previously recorded purchase orders. When sufficient number of delivery notes is generated, an exporter issues a commercial invoice and all supporting documents such as certificates of origin, manufacturers affidavits, etc.

Based on issued commercial invoices, either exporter's logistics department of a freight forwarder selects the most suitable carrier, consolidates cargo, creates transportation and compliance documents, reports compliance information (e.g., via AES in the USA) to the national authorities, receives permission to export and load the goods (e.g., via AMS in the USA), and delivers goods to the carrier.

The system monitors the export process in accordance with the configured workflow, validates all information in accordance with established business rules, and creates tracking events.

(2) Import Management

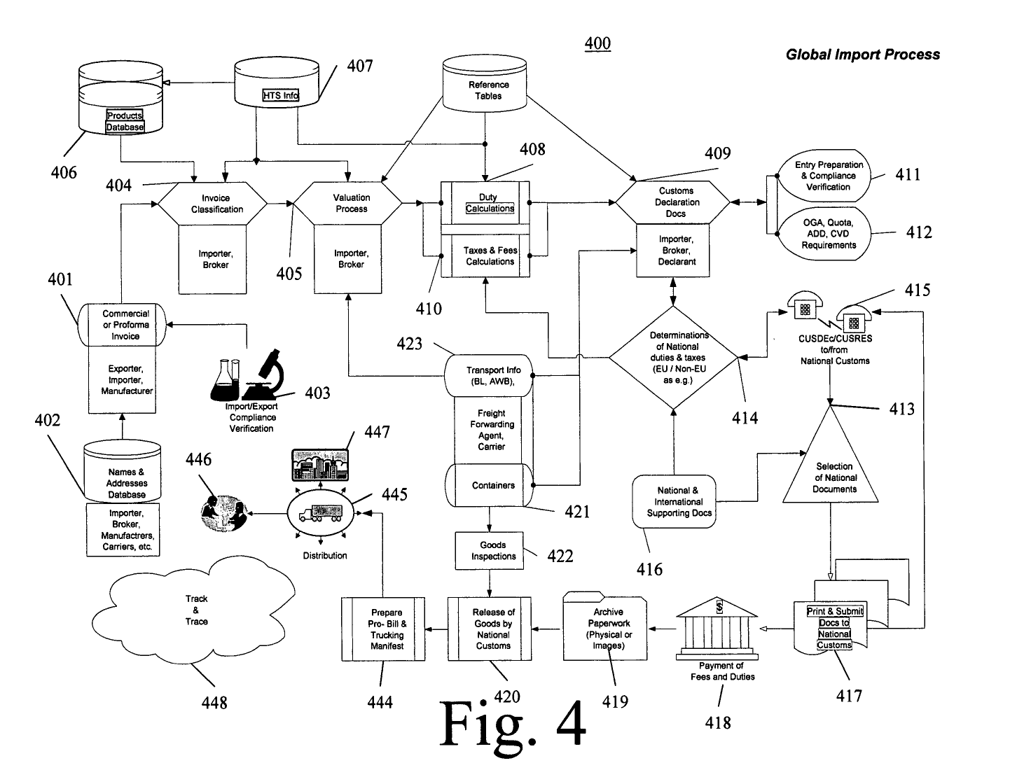

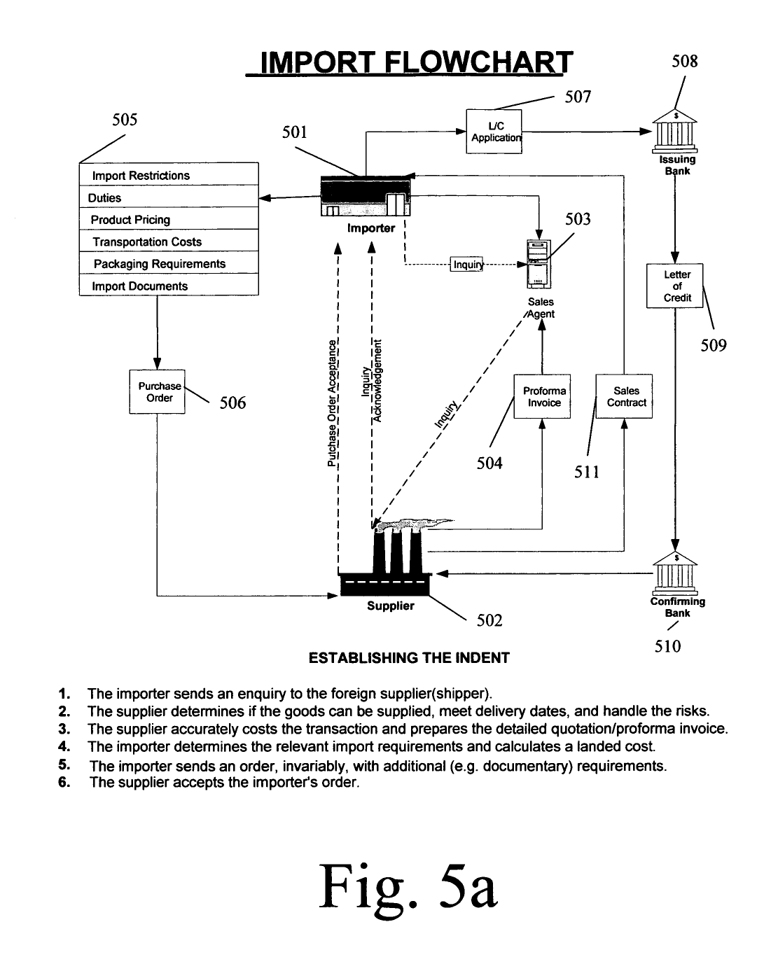

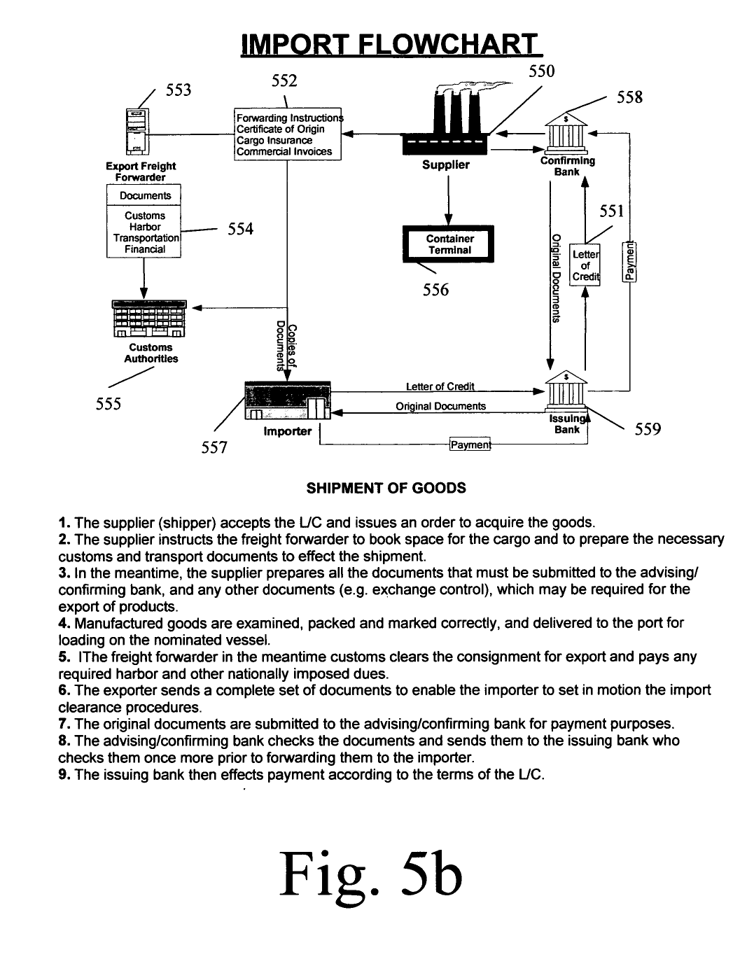

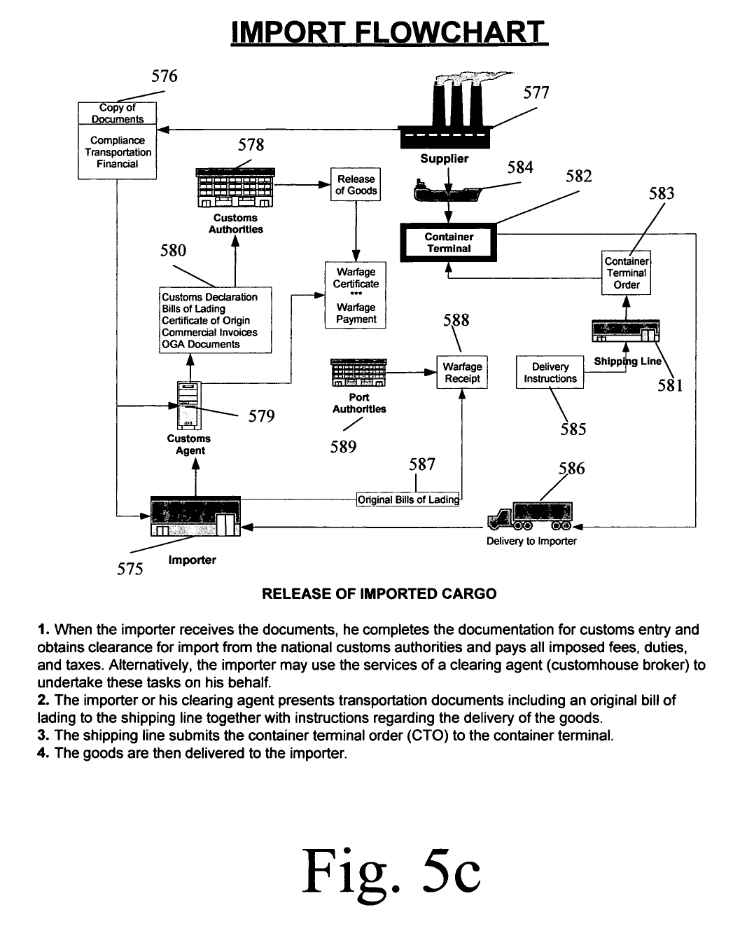

Referring now to FIGS. 4 and 5 that illustrate an overview of the automated components for management of the import process according to the teachings of the present invention.

FIG. 4 specifically details the Global Import Process (400) of the present invention. A commercial proforma invoice (401) initiates the process and immediately received Import/Export Compliance Verification (403). The proforma invoice (401) includes names and address of the importer, broker, manufacturer, carrier, etc and which is stored in the names and address database (402). The invoice is then classified (404) from a products database (406) and a valuation is processed (405). At the valuation stage transport information (423) is determined and distributed as necessary. Both the classification and valuation process incorporate HTS information (407). Next duty calculations (408), tax and fee calculations (410), entry preparation and compliance verification (411), and OGA Quote, ADD, CVD requirements (412) are completed to produce customs declaration documentation (409) for the importer, broker and Declarant.

One the goods are released by national customs (420) a pro-bill & trucking manifest (444) are prepared and distribution (445) occurs to people (446) and companies (447). During the global import process a track and trace (448) of all containers occurs for the duration of the distribution (445).

Next a determination of national duties and taxes for EU and Non-EU countries are computed (414) and reported and communication between national customs (415) is initiated. A selection of national documents (413) and national and international supporting documents (416) are printed and submitted to national customs (417). Payment of fees and duties (418) occurs and the paperwork is physically archived (419). Before the goods are released by national customs (420) the containers (421) must be inspected (422) and approved.

Transportation information may be received by the import freight forwarder first for the purposes of deconsolidation of goods and Customs notifications (e.g., via AMS in the USA). An importer receives shipment information consisting of commercial invoices, transportation documentation (bills of lading, houses, container listings, packing slips, etc.), and supporting compliance documentation (certificates of origin, textile certificates, etc.). The preferred way to receive these data is through established electronic connections but it can be entered manually as well. The data is verified for completeness and accuracy and missing information and documentation is requested from the determined appropriate source. The purchase order performance is performed by the system.

FIG. 5a illustrates the Import Flowchart for establishing the indent. The importer (501) send and inquiry to the foreign supplier (502). The foreign supplier (502) then determines if the goods can be shipped, meet delivery dates, and handle the risks utilizing a sales agent (503). The supplier (502) then accurately costs the transaction and prepares the detailed quotation/proforma invoice (504). The importer (501) then determines the relevant import requirements (505) and then calculates the landed costs and send a purchase order (506) while also submitting an line of credit application (507) to an issuing bank (508) which produces a letter of credit (509) that is then transmitted to a confirming bank (510) to ensure supplier (502) receives payment. In the meantime, the supplier prepares all the documents that may be required for the export of products. Manufactured goods are examined, packed, and marked correctly, and delivered to the container terminal (556) for loading on nominated vessel. The freight forwarder in the meantime customs clears the consignment for export and pays any required harbor and other nationally imposed dues. The supplier sends a complete set of documents to enable the importer (557) to set in motion the import clearance procedures. The original documents are submitted to the confirming bank (558) for payment purposes. The confirming bank (558) checks the documents and sends them to the issuing bank (559) that checks them once more prior to forwarding them to the importer. The issuing bank (559) then effects payment according to the terms of the letter of credit (551).

Now referring to FIG. 5c the release of imported cargo is illustrated. When the importer (575) receives the documents (576) from the supplier (577) he completes the documentation for customs entry and obtains clearance for import from the customs authorities (578) and pays all imposed fees, duties, and taxes. Alternatively, the importer (575) may use the services of a clearing agent (579) to undertake these tasks on his behalf. The importer (575) or his clearing agent (579) presents transportation documents (580) including an original bill of lading to this shipping line together with instructions regarding the deliver of the goods. The shipping line (581) submits the container terminal order (583) (CTO) to the container terminal (582) via any transport process (584) with delivery instructions (585) ending in actual delivery (586) to the importer (575). If the transport process is by boat, the importer (575) submits an original bill of lading (587) to obtain a warfage receipt (588) that is also verified by the port authorities (589).

Now referring to FIG. 5b, the shipment of goods import flow chart is illustrated. The supplier (550) accepts the letter of credit (551) and issues an order to acquire the goods. The supplier (550) instructs (552) the freight forwarder (553) to book cargo space for the cargo and to prepare the necessary customs and transport documents (554) for customs authorities (555) to effect shipment.

Referring now to FIGS. 6a & b that illustrate the import clearance process according to the teachings of the present invention. Validated commercial invoices are classified and rated for Customs clearance purposes. The estimated landed cost is calculated by the system at this point. An importer or its agent performs the import clearance either manually or electronically (e.g., via ABI in the USA) and transfer funds for the payment of duties, fees, and taxes. Upon release, the goods could be re-consolidated and delivered to their final destinations via local carriers. Received payable invoices are verified, recorded in the database, and transferred to importer's financial component. The actual landed cost is calculated by the system at this time.

FIG. 6a specifically details the Customs Clearance Process (600) of the present invention. A commercial proforma invoice (601) initiates the process. The invoice (601) is then classified (604), with information stored in a participants database (602) and a valuation is processed (605). The classification and valuation process incorporate HTS data (607) and reference tables (603) as necessary. Next duty calculations (608), tax and fee calculations (610), entry preparation and compliance verification (611), and OGA Quote, ADD, CVD requirements (612) are completed to produce customs declaration documentation (609) for the importer, broker and Declarant which may contain transportation data (629) and containers (630).

Next a determination of national duties and taxes for EU and Non-EU countries are computed (615) and reported and communication between national customs (614) is initiated. A selection of national documents (613) and national and international supporting documents (616) are printed and submitted to national customs (613). Payment of fees and duties (618) occurs and the paperwork is physically archived (619). The goods are released by national customs (620) after a pro-bill is prepared and handed over to a trucker (621). Distribution (622) occurs and proof of delivery (623) is provided. Finally the national reconciliation process (624) occurs and the national drawback process (625) is completed and stored in an export database (626). Transaction records are retained (627) per statutory requirements and the transaction is archived (628).

FIG. 6b illustrates the network schematic for implementing the present invention. Users (650, 651, 652) may connect globally (653) through a web server (654) or directly to the host server (655). The host server (655) allows communication (656) and execution (657) of the present invention. They system consists of many databses such as, ABI (658), Reconciliation Drawback Protest (661), All/RLF (659), AMS In-Bond (660). The ERP system (662) also consists of QW Import data (663) and QW IFF (664). Additional databases are used for: Track and Trace (665), Even Engine (666), XML Document Engine (667), Query Engine (668), document binder (669), and HTS classifier (670). Finally security applications (671 & 672) are used for authentication engine (673), user management (674), Ret. Data (675), parts master (676), additional components (677) and compliance (678).

Transportation information may be received by the import freight forwarder first for the purposes of deconsolidation of goods and Customs notifications (e.g., via AMS in the USA). An importer receives shipment information consisting of commercial invoices, transportation documentation (bills of lading, houses, container listings, packing slips, etc.), and supporting compliance documentation (certificates of origin, textile certificates, etc.). The preferred way to receive these data is through established electronic connections but it can be entered manually as well. The data is verified for completeness and accuracy and missing information and documentation is requested from the determined appropriate source. The purchase order performance is performed by the system.

(3) Re-Export Management

After an importer clears the goods it may be necessary to export them to the next country, either repackaged, re-manufactured, or in the same condition. Some parts of the shipment can be returned or destroyed.

Such actions may require filing drawback requests with Customs to receive a refund for paid import duties. Based on incoming and outgoing commercial invoices the system calculates refund amounts and submits the results together with supporting documents to Customs, either electronically or manually. New purchase orders can be verified or filled by using import commercial invoices.

Management Tools

All management tools are accessible anywhere in the world and do not require any proprietary software on the client's side.

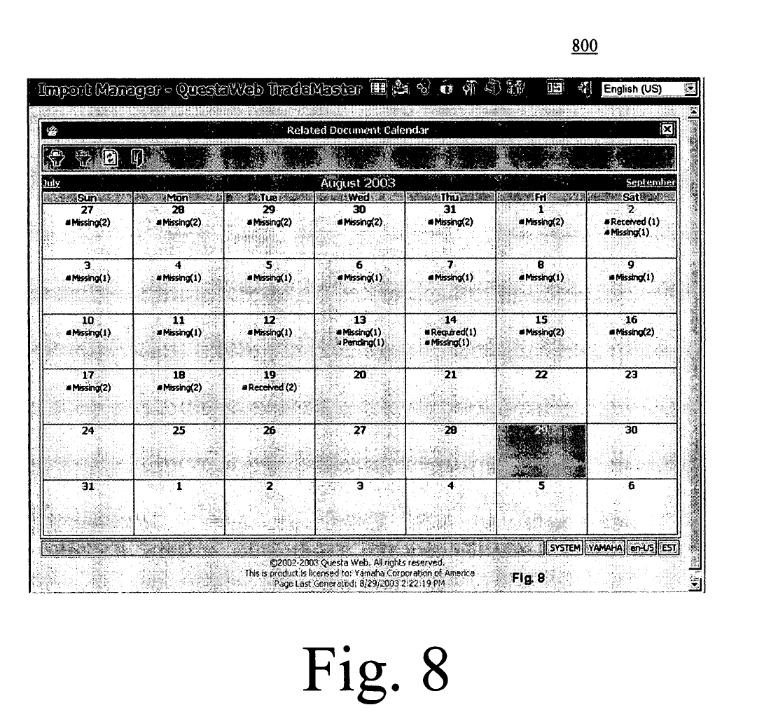

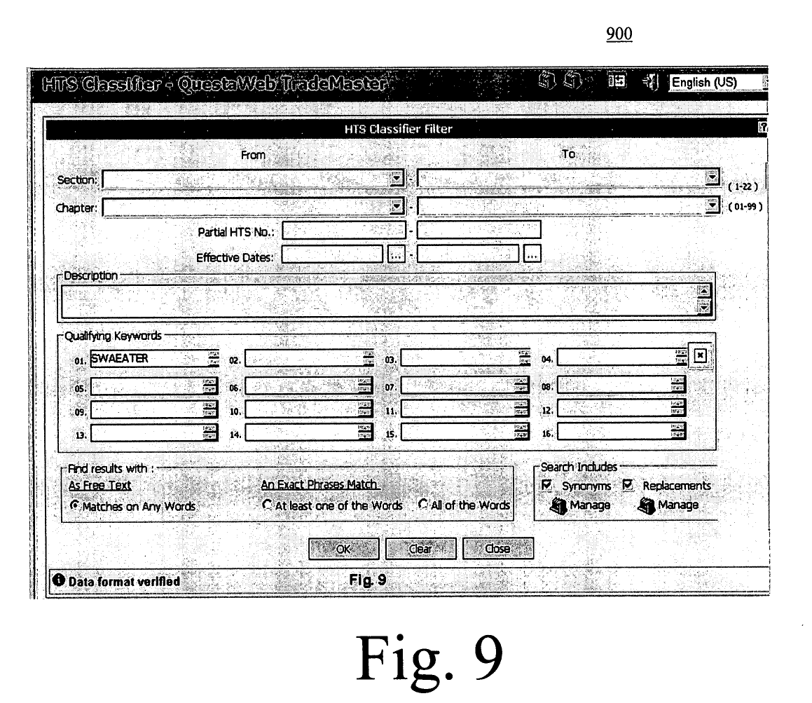

Referring now to FIG. 9, that shows a Harmonized Tariff Schedule (HTS) classifier screen (900). The tool helps to classify products by the detailed description (901) utilizing qualifying keywords (902).

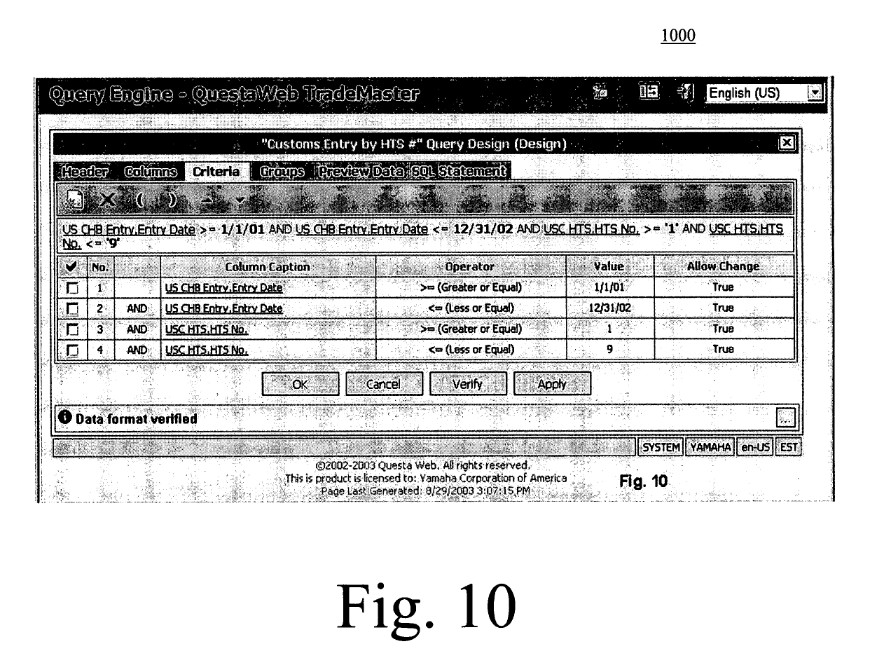

Referring now to FIG. 10, that shows a query screen of the system's reporting component, called “Query Builder” (1000). Query Builder (1000) allows creating and executing enterprise-wide analytical and management reports. The reports can be scheduled in advance, run in the batch mode, or ad-hoc. Legacy system databases (212) can be connected to this tool in the same fashion utilizing Legacy Application Software (213 & 214).

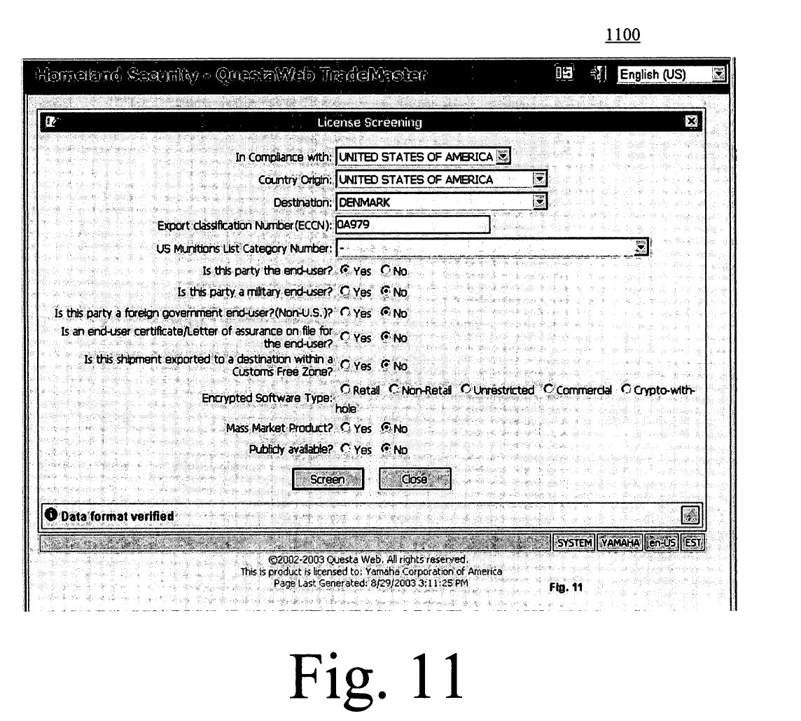

Referring now to FIG. 11, that shows a homeland security screen (1100). The tool checks transaction parties against multiple denied parties lists, both private and public, and verifies product licensing in formation.

No referring to FIG. 12, a sample database model (1200) of transaction cross-reference implementation using the separate cross-reference tables is illustrated.

In addition, other areas of may benefit from this method and adjustments to the method and process are anticipated. Thus, the scope of the invention should be determined by the appended claims and their legal equivalents, rather than by the examples given.

1. A computer-implemented method for proactive global trade and logistics management comprising:
(a) employing a centralized global multi-lingual data repository schema comprising data for generating trade, finance, and transportation documents, transmissions to government authorities, an executable plan for movement of goods, tracking performance of orders and deliveries, verifying national security and compliance to regulations;
(b) utilizing the method of inputting and storing of time sensitive and constant pre-classified and other pre-existing data necessary for all trade, finance, and logistics processes on the product/catalog/SKU level;
(c) maintaining said product data and using it for automation of trade, finance, and logistics processes;
(d) collecting and inputting to the management system estimated and actual trade, finance, and logistics data, said data being derived by an automated processes from real enterprise data at the points of origin;
(e) monitoring, verifying, and requesting missing mandatory said input data;
(f) utilizing ping data selectively for determining if and/or when the executable workflow is to be revised during said period of execution by said managing system, such that depending upon a magnitude of change, as represented by said input managing data, to said executable plan, said managing modules are selectively employed; and
(g) notifying related participants of changing conditions based on said determining.

2. A method according to claim 1, further comprising using pre-existing and said input data to determine the most effective rates, carriers, routes and sources of goods.

3. A method according to claim 2, further comprising using pre-existing and said input data to calculate consolidation, deconsolidation, and transportation requirements, and delivery methods.

4. A method according to claims 1, 2, or 3 further comprising:
(a) using said product and input data (managing information) to generate export trade, finance, and logistics documents, determine and verify compliance requirements and electronically transmit cross-border compliance and security data to respective national government authorities, pay regulated fees and taxes, obtain rights of passage of goods;
(b) using product and said input data (managing information) to generate import trade, finance, and logistics documents, determine and verify compliance requirements and electronically transmit cross-border compliance data to respective national government authorities, pay regulated duties, fees, and taxes, obtain the release of goods;
(c) using input managing data and pre-determined respective national government authorities regulations perform post entry processes, such as drawback, reconciliation, and protests; and
(d) process and archive input managing data, supporting reports, images, and documents in accordance with pre-determined respective national government authorities regulations.

5. A method according to claims 1, 2, 3, or 4 further comprising using said product and input data managing information to calculate and continuously upgrade estimated and actual landed costs and tracking information.

6. A method according to claims 1 or 4 further comprising implementing a revised executable workflow in response to “if . . . then” rules imposed on the input managing data.

7. A method according to claim 1, further comprising using the management system for generating the executable workflow and controlled by managing events, statuses, and binding documents.

8. A method according to claim 7, further comprising monitoring the executable workflow to accommodate any number of scheduling new managing events, statuses, or binding documents changing the time, and updating a previously scheduled time.

9. A computer-implemented method for using proactive multi-national integrated trade and logistics management system claim 1 further comprising:
(a) a logistics management system of at least one centralized database connected to the management system comprising managing information grouped into public and private segments including:
(i) means for enforcing security privileges to access managing information in the database; and
(ii) means for analyzing managing information and making it available to associated managing system components in the formats and views usable by said system components;
(iii) means for collecting and distributing managing information in the database over electronic connections to other computerized systems and through manual data entry using specialized user interfaces;
(iv) means and schema for storing and retrieving collected managing information;
(v) means for detecting changes in the database managing information and modifying behavior of affected system components;
(vi) means and schema for storing and retrieving detected changes in managing information in the database;
(vii) means for communicating of said changes to specified stakeholders;
(viii) means for pre-classifying and valuating products for cross-border transactions, both import and export;
(ix) means for specifying financial and compliance information on the product level and setting up triggers to activate managing events and statuses to configure an executable workflow;
(x) means for specifying transportation information on the products to select favorable freight and storage rates and routes;
(xi) means and schema for storing and retrieving said products information in the database;
(xi) means and schema for collection, storing, and retrieving homeland security data in the database; and
(xi) means and algorithms to search said homeland security data in the database.

10) The system of claim 2 further comprising means and schema to store transportation managing information, and algorithms that using said transportation managing information to determine the most effective rates, carriers, routes and sources of goods.

11) The system of claim 3 further comprising means using logistics information to calculate consolidation, deconsolidation, transportation requirements, delivery methods, generate and distribute documents automatically, and file security data electronically.

12) The system of claim 4 further comprising means using managing information to manage said trade, finance, and logistics processes including:
(i) means to generate export trade, finance, and logistics documents, determine and verify compliance requirements and electronically transmit cross-border compliance and security data to respective national government authorities, pay regulated fees and taxes, obtain rights of passage of goods;
(ii) means to generate import trade, finance, and logistics documents, determine and verify compliance requirements and electronically transmit cross-border compliance data to respective national government authorities, pay regulated duties, fees, and taxes, obtain the release of goods;
(iii) means to perform post entry processes, such as drawback, reconciliation, and protests; and
(iv) means and algorithms to process and archive managing data, supporting reports, images, and documents in accordance with pre-determined respective national government authorities regulations.

13) The system of claim 5 further comprising means, schema, and algorithms to calculate and continuously upgrade estimated and actual landed costs and tracking information.

14) The system of claim 6 further comprising means and algorithms for implementing a revised executable workflow in response to “if . . . then” rules imposed on the input managing data.

15) The system of claim 7 further comprising means for generating the executable workflow and controlled by managing events, statuses, and binding documents.

16) The system of claim 8 further comprising means for monitoring the executable workflow to accommodate any number of scheduling new managing events, statuses, or binding documents changing the time, and updating a previously scheduled time.
